(19) United States
(12) Patent Application Publication
(10) Pub. No.: US 2026/0366684 A1
(43) Pub. Date: Nov. 19, 2026

(54) ILLUMINATION DEVICE FOR A VEHICLE HEADLAMP

(71) Applicant: ZKW Group GmbH, Wieselburg (AT)

(72) Inventor: Kammerer FLORIAN, Loosdorf (AT)

(73) Assignee: ZKW Group GmbH, Wieselburg (AT)

(21) Appl. No.: 19/678,122

(22) Filed: May 14, 2026

(30) Foreign Application Priority Data
May 19, 2025 (EP) 25177218.2

(51) Int. Cl. F21S 41/25; F21S 41/29

(52) U.S. Cl. CPC F21S 41/25; F21S 41/295

(57) ABSTRACT

Illumination device (10) for a motor vehicle headlamp, comprising:
at least one light source (50) disposed on a support element (60),
an optic body (100),
a holder (300) configured to hold the optic body (100), the projection lens (200) and the support element (60), wherein the holder (300) comprises an insertion opening (310) and a mounting opening (320), wherein the optic body (100) is insertable into the holder (300) through the insertion opening (310), and wherein the projection lens (200) can be brought into an intermediate position (IP) on the holder (300) via the mounting opening (320),
a pre-fixation device (400) for pre-fixing of the projection lens (200) in the intermediate position (IP) in the mounting opening (320) on the holder (300),
an aligning device (500) for aligning the optic body (100) and the projection lens (200) relative to each other in an aligned position (AP),
a fixation device (600) for securing the support element (60) over the insertion opening (310) on the holder (300), wherein the support element (60), when fixed to the holder, presses against at least a part of the light input side (110) of the optic body (100), wherein the optic body (100) is thereby brought into an end position (EP) within the holder (300) and, by means of the optic body (100), the projections lens (200) is brought into an end position (EP) on the holder.

The invention relates to an illumination device for a motor vehicle headlamp, wherein the illumination device is configured to radiate a light distribution in front of the illumination device in a main direction.

In the field of vehicle headlamps, precise alignment of optical components such as lenses and light guides is essential for generating light distributions that meet regulatory requirements and performance expectations. Known headlamp modules often suffer from complex assembly processes due to the need for manual fine adjustment of optical components. Misalignments between the optic body and the projection lens can result in poor light output, irregular beam shapes, or inefficient light coupling, especially when tolerances stack during the manufacturing process.

Additionally, conventional designs often lack effective pre-fixation or positioning aids during assembly, which increases the risk of misplacement or damage to delicate optical elements. Mechanical fastening methods can be cumbersome, and they may not reliably maintain alignment under thermal cycling or vibration during vehicle operation.

Therefore, there is a need for an illumination device with improved component integration, alignment accuracy, and assembly efficiency.

It is an object of the invention to provide an enhanced illumination device and an enhanced method for aligning the illumination device.

To achieve this object the illumination device comprises:
at least one light source,
a support element configured to hold the at least one light source,
an optic body disposed downstream of the light source along the main direction, wherein the optic body is configured to receive light of the at least on light source via a light input side of the optic body, wherein light which enters the optic body via the light input side is coupled out via a light exit side of the optics body,
a projection lens disposed downstream of the optic body along the main direction, wherein the projection lens is configured to receive the light coupled out from the light exit side of the optic body via a light entry side of the projection lens, and to project the light received from the light exit side of the optic body in front of the illumination device in the main direction in form of a light distribution,
a holder configured to hold the optic body, the projection lens and the support element, wherein the holder comprises an insertion opening and a mounting opening opposite the insertion opening in the direction of the main direction, wherein the optic body is insertable into the holder through the insertion opening, and wherein the projection lens can be brought into an intermediate position on the holder via the mounting opening,
a pre-fixation device for pre-fixing of the projection lens in the intermediate position in the mounting opening on the holder, wherein the pre-fixation device comprising a first engaging element and a second engaging element, which are configured to engage with each other when the projection lens is brought into the intermediate position on the holder,
an aligning device for aligning the optic body and the projection lens relative to each other in an aligned position, wherein the aligning device comprises an aligning structure and an aligning counter-structure, which are configured to interlock positively with each other in the aligned position of the optic body and the projection lens, wherein the aligning structure is disposed on the projection lens, wherein the aligning counter-structure is disposed on the optic body,
a fixation device for securing the support element over the insertion opening on the holder, wherein the support element, when fixed to the holder, presses against at least a part of the light input side of the optic body, wherein the optic body is thereby brought into an end position within the holder and, by means of the optic body, the projections lens is brought into an end position on the holder.

This provides several technical advantages, particularly with regard to compactness, ease of assembly, and precise alignment of the optical components. By arranging the key elements—including the light source, optic body, projection lens, and support structure—along a defined main direction of light emission, the overall system ensures an efficient and controlled distribution of light in front of the headlamp. The design enables the optic body to be inserted into the holder from one side, while the projection lens can be introduced from the opposite side into an intermediate position. This dual-access configuration simplifies the assembly process and reduces the risk of misalignment. The provision of a pre-fixation device that temporarily holds the projection lens in place during the assembly allows for stable handling prior to final fixation. Additionally, the aligning device with positively interlocking features on both the optic body and the projection lens enables a highly accurate and reproducible positioning of these elements relative to each other, ensuring optimal optical performance and reducing the need for complex calibration or adjustment steps during production.

Advantageously, the aligning structure comprises at least one protrusion and at least one recess, wherein the aligning counter-structure comprises at least one protrusion and at least one recess.

The implementation of at least one protrusion and one recess on each of the aligning elements—on both the projection lens and the optic body—further enhances the positional accuracy and mechanical stability of the assembly. This mutual engagement prevents unintentional shifting and supports a defined end alignment without requiring additional tools or fixtures.

Advantageously, the projection lens has two ends opposite to each other along an axis traverse to the main direction, wherein the aligning structure is disposed on each end respectively.

Advantageously, the light exit side of the optic body comprises a light exit surface, wherein the light exit surface lies in the focal plane of the projection lens when the optic body and the projection lens are aligned to each other via the aligning device.

This arrangement ensures that the light emitted by the light source is accurately focused and projected into the desired beam pattern, which significantly improves the optical efficiency and the quality of the resulting light distribution, while also minimizing losses or distortion.

Advantageously, the fixation device is configured as at least one screw connection.

This allows for a secure and durable fastening of the support element to the holder. This configuration not only enhances mechanical robustness but also contributes to the long-term stability of the optical alignment, as the fixation force acts directly on the optic body and thereby indirectly ensures the final positioning of the projection lens.

Advantageously, the first engaging element is configured as a snap-in component, and the second engaging element is configured as a counter-component to the snap-in component, or the second engaging element is configured as a snap-in component, and the first engaging element is configured as a counter-component to the snap-in component.

This simplifies assembly and disassembly procedures, which is especially advantageous in modular systems or repair scenarios.

Advantageously, the first engaging element is disposed on the holder, wherein the second engaging element is disposed on the projection lens, or the other way around.

Advantageously, when the projection lens is in the intermediate position, the engaged first and second engaging element of the pre-fixing device allow a clearance at least along the main direction.

The allowance of clearance (or play), at least along the main direction, accommodates necessary positional tolerances and facilitates the subsequent insertion of the optic body without mechanical interference, thereby streamlining the transition from pre-assembly to final assembly.

Advantageously, the aligning device aligns the optic body and the projection lens relative to each other in x-, y- and z-direction.

This ensures full three-dimensional positioning of the optical components. This comprehensive alignment mechanism guarantees that the beam pattern formed by the system remains within required regulatory specifications and supports consistent light performance across different units.

Advantageously, the optic body and the projections lens are made of the same material or are made of different materials.

The object is also achieved by a motor vehicle headlamp comprising at least one illumination device according to the invention.

The object is also achieved by a method for assembling an illumination device according to the invention, wherein the method comprises the following steps in chronological order:
a) Pre-fixing the projection lens into the mounting opening of the holder by the pre-fixing device;
b) Inserting the optic body into the holder via the insertion opening of the holder;
c) Aligning the optic body and the projection lens in the aligning position by the aligning device;
d) fixing the support element over the insertion opening on the holder, and thereby bringing the projection lens and the optic body into an end position on the holder.

The stepwise approach—starting with the pre-fixation of the projection lens, followed by the insertion of the optic body, and concluding with the fixation of the support element—not only ensures process reliability and mechanical consistency but also reduces the likelihood of assembly errors and simplifies the training requirements for production personnel.

### SHORT DESCRIPTION OF THE DRAWINGS

In the following, in order to further demonstrate the present invention, illustrative and non-restrictive embodiments are discussed, as shown in the drawings, which show:

FIG. 1 an exemplary illumination device in a perspective cross section along a main direction, wherein the illumination device comprises a support element having light sources, an optic body, a projection lens, a holder which holds the support element, the optic body and the projection lens;

FIG. 2 a perspective view of the projection lens and the optic body, wherein the projection lens comprises an aligning structure and the optic body comprises an aligning counter-structure, which are part of an aligning device, wherein the projection lens and the optic body are in an aligned position;

FIG. 3 a front perspective view of the illumination device, wherein the holder comprises a pre-fixation device for pre-fixing the projection lens onto the holder;

FIG. 4 a perspective view of the aligning structure disposed on the projection lens;

FIG. 5 a perspective view of the aligning counter-structure disposed on the optic body;

FIG. 6 inserting the projection lens onto the holder via the mounting opening;

FIG. 7 prefixing the projection lens on the holder via the pre-fixing device and bringing the projection lens into an intermediate position;

FIG. 8 inserting the optic body into the holder via the insertion opening;

FIG. 9 bringing the optic body and the projection lens in the aligned position;

FIG. 10 bringing the support element over the insertion opening of the holder; and

FIG. 11 fixing the support element on the holder via the fixation device and bringing the projection lens and the optic body in an end position.

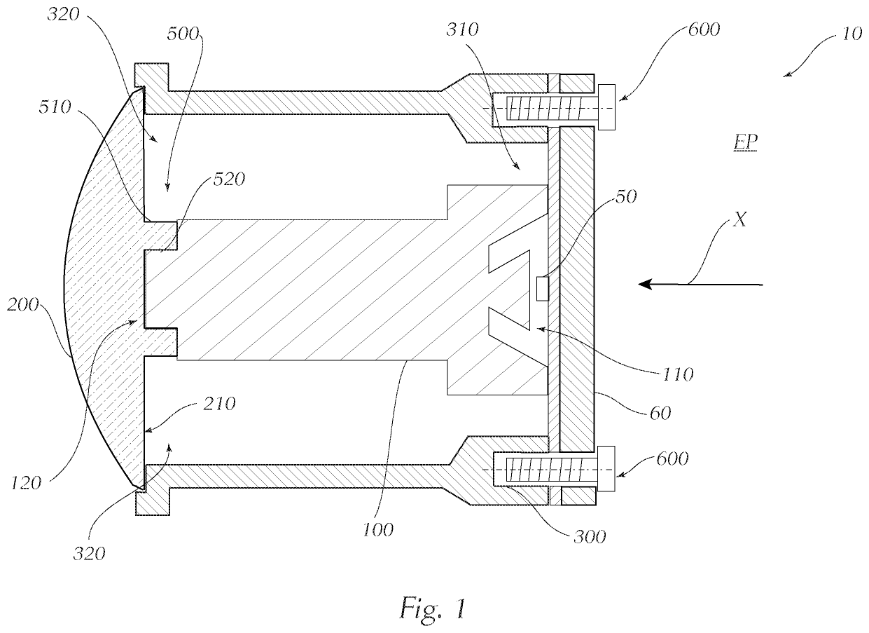

FIG. 1 shows an exemplary illumination device 10 of a motor vehicle headlamp, wherein the illumination device 10 is configured to radiate a light distribution in front of the illumination device 10 in a main direction X.

The illumination device 10 comprises a plurality of light sources 50, a support element 60 configured to hold the light sources 50, and an optic body 100 disposed downstream of the light sources 50 along the main direction X.

The optic body 100 is configured to receive light of the light sources 50 via a light input side 110 of the optic body 100, wherein light which enters the optic body 100 via the light input side 110 is coupled out via a light exit side 120 of the optics body 100.

Further, the illumination device 10 comprises a projection lens 200 disposed downstream of the optic body 100 along the main direction X, wherein the projection lens 200 is configured to receive the light coupled out from the light exit side 120 of the optic body 100 via a light entry side 210 of t he projection lens 200, and to project the light received from the light exit side 120 of the optic body 100 in front of the illumination device 10 in the main direction X in form of a light distribution. The optic body 100 and the projections lens 200 are made of the same material or are made of different materials.

Moreover, the illumination device 10 comprises a holder 300 configured to hold the optic body 100, the projection lens 200 and the support element 60, wherein the holder 300 comprises an insertion opening 310 and a mounting opening 320 opposite the insertion opening 310 in the direction of the main direction X.

The optic body 100 is insertable into the holder 300 through the insertion opening 310, and wherein the projection lens 200 can be brought into an intermediate position IP on the holder 300 via the mounting opening 320, which can be seen also for example in FIG. 3.

Further, the illumination device 10 comprises a pre-fixation device 400 for pre-fixing of the projection lens 200 in the intermediate position IP in the mounting opening 320 on the holder 300, wherein the pre-fixation device 400 comprising a first engaging element 400a and a second engaging element 400b, which are configured to engage with each other when the projection lens 200 is brought into the intermediate position IP on the holder 300. The second engaging element 400a is configured as a snap-in component, and the first engaging element 400b is configured as a counter-component to the snap-in component. However, this could also be the other way around. In the shown example, the first engaging element 400a is disposed on the holder 300, wherein the second engaging element 400b is disposed on the projection lens 200.

Further, when the projection lens 200 is in the intermediate position IP, the engaged first and second engaging element 400a, 400b of the pre-fixing device 400 allow a clearance at least along the main direction X.

Further, the illumination device 10 comprises an aligning device 500 for aligning the optic body 100 and the projection lens 200 relative to each other in an aligned position AP.

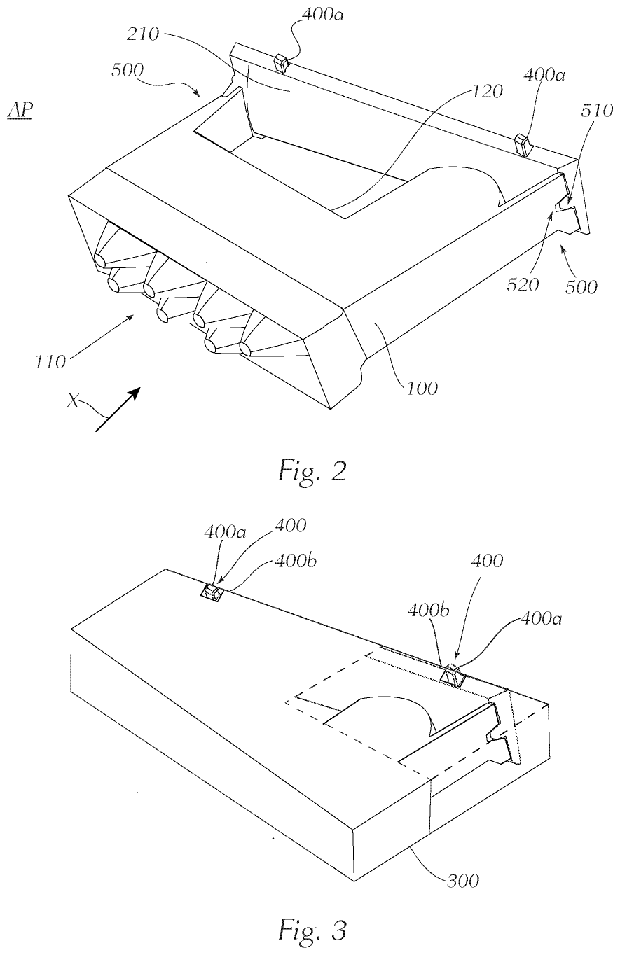

The aligning device 500 comprises an aligning structure 510 and an aligning counter-structure 520, which are configured to interlock positively with each other in the aligned position AP of the optic body 100 and the projection lens 200, wherein the aligning structure 510 is disposed on the projection lens 200, wherein the aligning counter-structure 520 is disposed on the optic body 100. Such an aligned position AP of the projection lens 200 and the optic body 100 can be seen for example in FIG. 2. The light exit side 120 of the optic body comprises a light exit surface 130, wherein the light exit surface 130 lies in the focal plane of the projection lens 200 when the optic body 100 and the projection lens 200 are aligned to each other via the aligning device 500.The projection lens 200 having two ends opposite to each other along an axis traverse to the main direction X, wherein the aligning structure 510 is disposed on each side respectively.

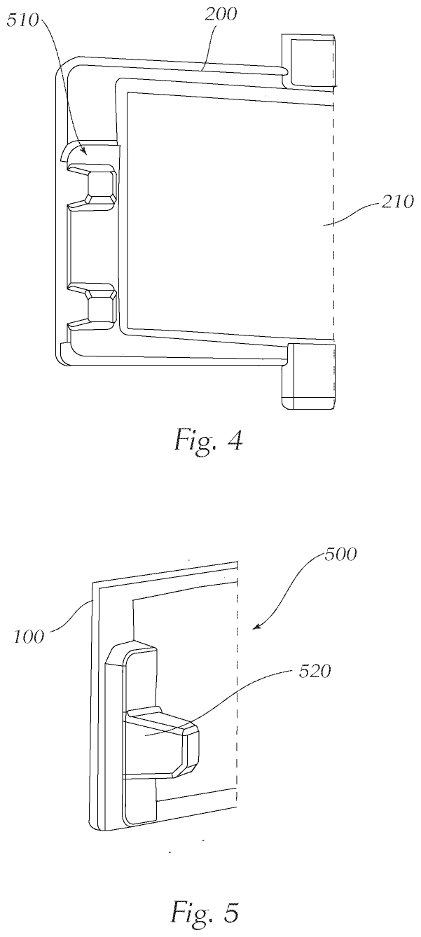

In the shown example, the aligning structure 510 comprises protrusions and one recess on each end-traverse to the main direction X-of the projection lens 200, wherein one end of the projection lens 200 with the aligning structure 510 can be seen in FIG. 4.

In general, the aligning structure on both sides of the projection lens 200 does not necessarily have to be the same. In other words, the projection lens has—for example—the same type of recess on both sides. Or there are two protrusions and a recess at one end of the projection lens 200 and one protrusion and two recesses at the other end.

The aligning counter-structure 520, in the shown example, comprises one protrusion and two recesses at each end—traverse to the main direction X—of the optic body 100, wherein one end of the optic body 100 with the aligning counter-structure 520 can be seen in FIG. 5. The aligning device 500 aligns the optic body 100 and the projection lens 200 relative to each other in x-, y- and z-direction.

Further, the illumination device 10 comprises a fixation device 600 for securing the support element 60 over the insertion opening 310 on the holder 300, wherein the support element 60, when fixed to the holder, presses against at least a part of the light input side 110 of the optic body 100, wherein the optic body 100 is thereby brought into an end position EP within the holder 300 and, by means of the optic body 100, the projections lens 200 is brought into an end position EP on the holder. The fixation device 600 in the shown example is configured as at least one screw connection.

Moreover, for assembling the illumination device described before, the following steps are to be performed in chronological order:
a) Pre-fixing the projection lens 200 into the mounting opening 320 of the holder 300 by the pre-fixing device 400;
b) Inserting the optic body 100 into the holder 300 via the insertion opening 310 of the holder 300;
c) fixing the support element 60 over the insertion opening 310 on the holder 300, and thereby bringing the projection lens 200 and the optic body 100 into an end position EP on the holder 300.

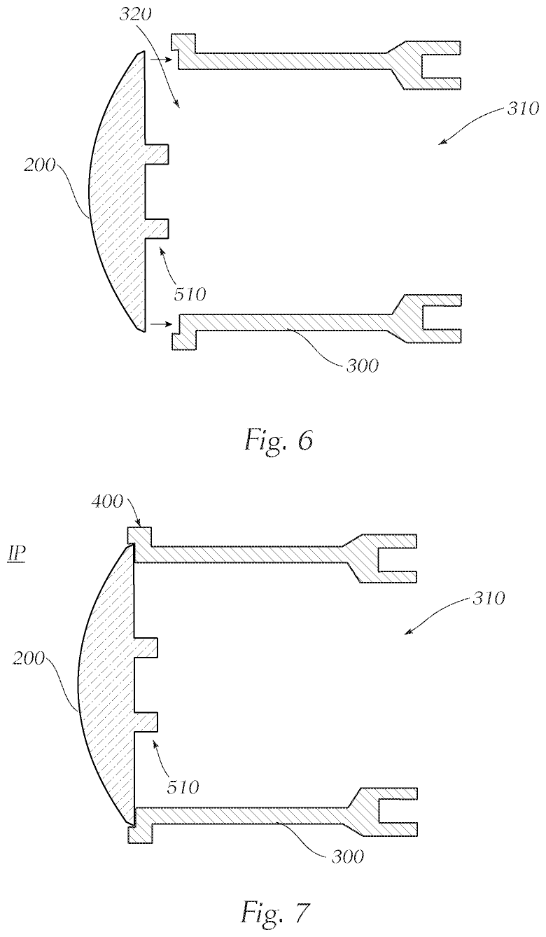

FIG. 6 to FIG. 11 show the steps of assembling the exemplary illumination device 10. In FIG. 6, the projection lens 200 is inserted into the mounting opening 320 of the holder 320 in order to pre-fixing the projection lens 200 to the holder 300 by the pre-fixing device 400 as indicated in FIG. 7. By pre-fixing the projection lens 200, the projection lens 200 is brought into an intermediate position IP on the holder 300. In this intermediate position IP, the pre-fixing device 400 allows a clearance at least along the main direction X. In other words, the projection lens 200 is moveable to some degree.

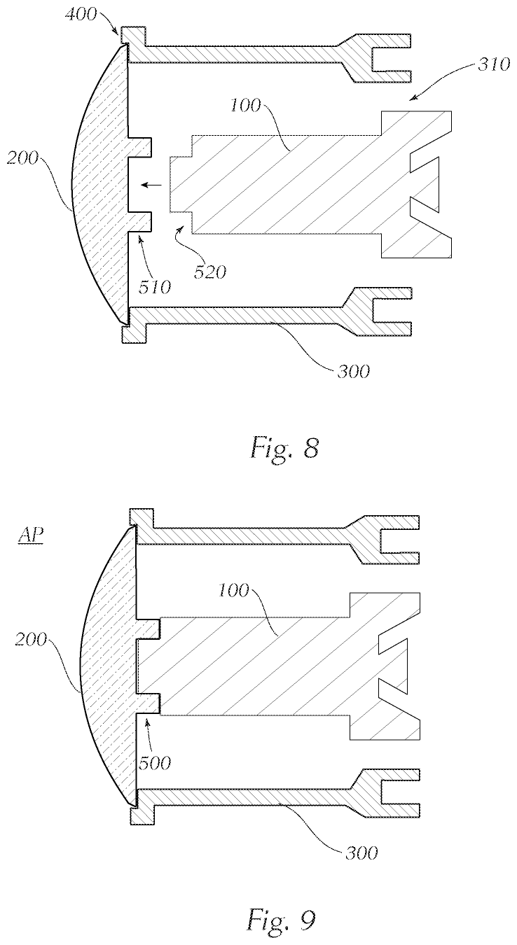

In FIG. 8, the optic body 100 is inserted into the holder 300 via the insertion opening 310 of the holder 300 in order to bring the optic body 100 and the projection lens 200 into the aligned position AP, in which the aligning structure 510 of the projection lens 200 and the aligning counter-structure 520 of the optic body 100 are positively interlocked with each other. FIG. 9 shows the projection lens 200 and the optic body 100 in the aligned position AP.

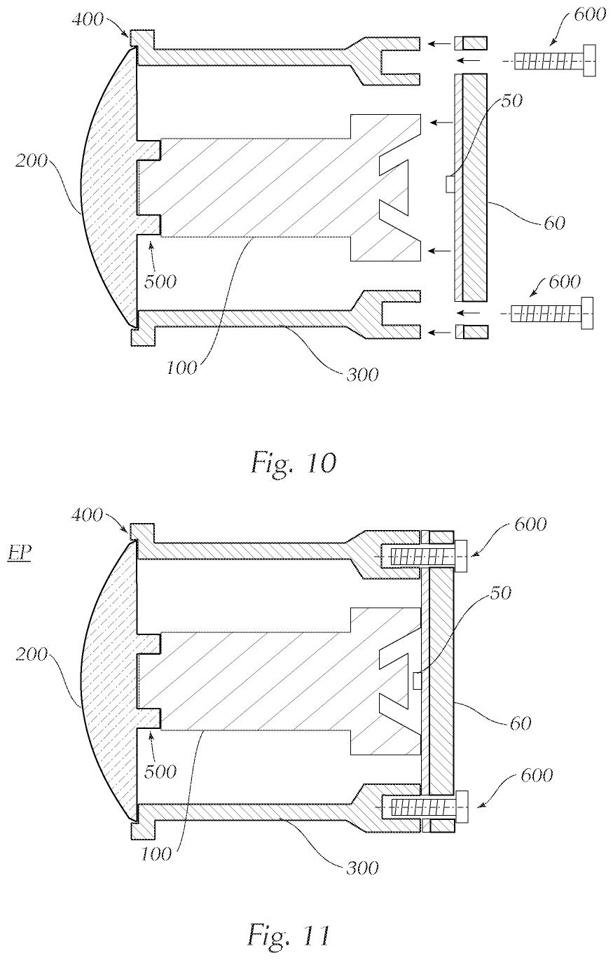

In FIG. 10, the support element 60 is brought over the insertion opening 310 of the holder 300 in order to fixate the support element 60 on the holder 300 and over the insertion opening 310, thereby closing the insertion opening 310 and bringing the projection lens 200 and the optic body 100 into an end position EP on the holder 300. In FIG. 11, the support element 60 is fixated on the holder 300 via the fixation device 600, in this example screws. By fixating the support element 60 on the holder 300, the support element 60 pushes the optic body along the main direction X on the projection lens 200. In this way, the projection lens 200 will be pushed to the extent of the clearance in the pre-fixation device 400.

The invention is not limited to the embodiments shown but is defined by the entire scope of protection of the claims. Individual aspects of the invention or of the embodiments can also be taken up and combined with one another. Any reference signs in the claims are exemplary and serve only the purpose of allowing easier review without restricting the claims.

### LIST OF REFERENCE SYMBOLS

Illumination device . . . 10
Light sources . . . 50
Support element . . . 60
Optic body . . . 100
Light input side . . . 110
Light exit side . . . 120
Projection lens . . . 200
Light entry side . . . 210
Holder . . . 300
Insertion opening . . . 310
Mounting opening . . . 320
Pre-fixation device . . . 400
First engaging element . . . 400a
Second engaging element . . . 400b
Aligning device . . . 500
Aligning structure . . . 510
Aligning counter-structure . . . 520
Fixation device . . . 600
Aligned position . . . AP
End position . . . EP
Intermediate Position . . . IP
Main direction . . . X

1. Illumination device (10) for a motor vehicle headlamp, wherein the illumination device (10) is configured to radiate a light distribution in front of the illumination device (10) in a main direction (X), wherein the illumination device (10) comprising:
at least one light source (50)
a support element (60) configured to hold the at least one light source (50),
an optic body (100) disposed downstream of the light source (50) along the main direction (X), wherein the optic body (100) is configured to receive light of the at least on light source (50) via a light input side (110) of the optic body (100), wherein light which enters the optic body (100) via the light input side (110) is coupled out via a light exit side (120) of the optics body (100),
a projection lens (200) disposed downstream of the optic body (100) along the main direction (X), wherein the projection lens (200) is configured to receive the light coupled out from the light exit side (120) of the optic body (100) via a light entry side (210) of the projection lens (200), and to project the light received from the light exit side (120) of the optic body (100) in front of the illumination device (10) in the main direction (X) in form of a light distribution,
a holder (300) configured to hold the optic body (100), the projection lens (200) and the support element (60), wherein the holder (300) comprises an insertion opening (310) and a mounting opening (320) opposite the insertion opening (310) in the direction of the main direction (X), wherein the optic body (100) is insertable into the holder (300) through the insertion opening (310), and wherein the projection lens (200) can be brought into an intermediate position (IP) on the holder (300) via the mounting opening (320),
a pre-fixation device (400) for pre-fixing of the projection lens (200) in the intermediate position (IP) in the mounting opening (320) on the holder (300), wherein the pre-fixation device (400) comprising a first engaging element (400a) and a second engaging element (400b), which are configured to engage with each other when the projection lens (200) is brought into the intermediate position (IP) on the holder (300),
an aligning device (500) for aligning the optic body (100) and the projection lens (200) relative to each other in an aligned position (AP), wherein the aligning device (500) comprises an aligning structure (510) and an aligning counter-structure (520), which are configured to interlock positively with each other in the aligned position (AP) of the optic body (100) and the projection lens (200), wherein the aligning structure (510) is disposed on the projection lens (200), wherein the aligning counter-structure (520) is disposed on the optic body (100),
a fixation device (600) for securing the support element (60) over the insertion opening (310) on the holder (300), wherein the support element (60), when fixed to the holder, presses against at least a part of the light input side (110) of the optic body (100), wherein the optic body (100) is thereby brought into an end position (EP) within the holder (300) and, by means of the optic body (100), the projections lens (200) is brought into an end position (EP) on the holder.

2. Illumination device according to claim 1, wherein the aligning structure (510) comprises at least one protrusion and at least one recess, wherein the aligning counter-structure (520) comprises at least one protrusion and at least one recess.

3. Illumination device according to claim 1, wherein the projection lens (200) having two ends opposite to each other along an axis traverse to the main direction (X), wherein the aligning structure (510) is disposed on each end respectively.

4. Illumination device according to claim 1, wherein the light exit side (120) of the optic body comprises a light exit surface (130), wherein the light exit surface (130) lies in the focal plane of the projection lens (200) when the optic body (100) and the projection lens (200) are aligned to each other via the aligning device (500).

5. Illumination device according to claim 1, wherein the fixation device (600) is configured as at least one screw connection.

6. Illumination device according to claim 1, wherein the first engaging element (400a) is configured as a snap-in component, and the second engaging element (400b) is configured as a counter-component to the snap-in component,
or
the second engaging element (400a) is configured as a snap-in component, and the first engaging element (400b) is configured as a counter-component to the snap-in component.

7. Illumination device according to claim 1, wherein when the projection lens (200) is in the intermediate position (IP), the engaged first and second engaging element (400a, 400b) of the pre-fixing device (400) allow a clearance at least along the main direction (X).

8. Illumination device according to claim 1, wherein the aligning device (500) aligns the optic body (100) and the projection lens (200) relative to each other in x-, y- and z-direction.

9. Motor vehicle headlamp comprising at least one illumination device (10) according to claim 1.

10. Method for assembling an illumination device according to claim 1, wherein the method comprises the following steps in chronological order:
a) Pre-fixing the projection lens (200) into the mounting opening (320) of the holder (300) by the pre-fixing device (400);
b) Inserting the optic body (100) into the holder (300) via the insertion opening (310) of the holder (300);
c) Aligning the optic body (100) and the projection lens (200) in the aligning position (AP) by the aligning device (500);
d) Fixing the support element (60) over the insertion opening (310) on the holder (300), and thereby bringing the projection lens (200) and the optic body (100) into an end position (EP) on the holder (300).
